(19) United States
(12) Patent Application Publication
(10) Pub. No.: US 2021/0086702 A1
(43) Pub. Date: Mar. 25, 2021

(54) MODULAR UTILITY INSERT FOR A VEHICLE

(71) Applicant: GM GLOBAL TECHNOLOGY OPERATIONS LLC, Detroit, MI (US)

(72) Inventors: Blaine D. Christensen, Sterling Heights, MI (US); William A. Mcdonald, Waterford, MI (US); Paul C. Arnone, Royal Oak, MI (US)

(21) Appl. No.: 16/575,802

(22) Filed: Sep. 19, 2019

(51) Int. Cl. B60R 9/00; B60R 3/02; B60N 3/02

(52) U.S. Cl. CPC B60R 9/00; B60N 3/02; B60R 3/02

(57) ABSTRACT

An automotive vehicle includes a frame, an occupant cabin coupled to the frame, and a cargo box coupled to the frame. The occupant cabin has a fore wall and an aft wall. The cargo box has a fore sidewall positioned aft of the cabin aft wall. The vehicle additionally includes an insert disposed between the cabin aft wall and the cargo box fore sidewall. The insert includes an interior storage space.

### INTRODUCTION

The present invention relates generally to automotive vehicles, and more particularly to pickup trucks having aft cargo areas.

Conventional pickup trucks or SUVs include an occupant cab for carrying passengers, which may include a rear seat section behind a driver seat, and a cargo box behind the occupant cab for carrying cargo. Such vehicles may be assembled using a body-on-frame construction method, wherein a separate body, comprising the occupant cab and cargo box, is mounted on a relatively rigid vehicle frame or chassis carrying the powertrain.

### SUMMARY

An automotive vehicle according to the present disclosure includes a frame, an occupant cabin coupled to the frame, and a cargo box coupled to the frame. The occupant cabin has a fore wall and an aft wall. The cargo box has a fore sidewall positioned aft of the cabin aft wall. The vehicle additionally includes an insert disposed between the cabin aft wall and the cargo box fore sidewall. The insert includes an interior storage space.

In an exemplary embodiment a removable drawer is disposed in the interior storage space. In such embodiments, the drawer may be lockable to selectively inhibit access to the drawer.

In an exemplary embodiment, a step is coupled to the insert. In such embodiments, the insert may have a first side proximate a driver side of the occupant cabin and a second side proximate a passenger side of the occupant cabin. The step may be coupled at the first side of the insert, and a second step may be coupled to the second side of the insert.

In an exemplary embodiment, the aft wall is provided with a rear window, and the insert includes a lower portion and an upper portion. The lower portion is in register with the cargo box, and the upper portion extends about the periphery of the rear window. Such embodiments may additionally include a handle secured to the upper portion.

A method of configuring a vehicle according to an embodiment of the present disclosure includes providing a frame and providing an occupant cabin coupled to the frame. The method additionally includes selecting among a first cargo box and a second cargo box. The second cargo box has a length exceeding the first cargo box. In response to the first cargo box being selected, an insert is disposed between the occupant cabin and the first cargo box. The insert has an interior storage space. The method further includes coupling the cargo box to the frame.

In an exemplary embodiment, the method further includes coupling the insert to the occupant cabin.

In an exemplary embodiment, the method further includes providing the insert with at least one removable drawer disposed in the interior storage space.

In an exemplary embodiment, in response to the second cargo box being selected, the cargo box is coupled to the frame with no insert therebetween.

As may be seen, the present disclosure enables flexible configuration of a vehicle according to the operator's needs, and moreover does so while utilizing a standard set of body and frame components. The above and other additional advantages will be made clear in the description below and accompanying drawings.

### BRIEF DESCRIPTION OF THE DRAWINGS

FIG. 1 is a schematic view of a prior art vehicle assembly;

FIG. 2 is a side view of a body assembly according to an embodiment of the present disclosure;

FIG. 3 is an isometric view of a body assembly according to an embodiment of the present disclosure;

FIG. 4 is a detail view of a body assembly according to an embodiment of the present disclosure;

FIGS. 5A-5C are schematic representations of a method of configuring a vehicle according to an embodiment of the present disclosure; and

FIG. 6 is a flowchart representation of a method of configuring a vehicle according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Referring now to FIG. 1, a vehicle 10 according to the prior art is illustrated. The vehicle 10 has a so-called body-on-frame construction, where a separate body 12 is mounted on a relatively rigid vehicle frame 14 or chassis carrying the powertrain. The body 12 includes an occupant cabin or cab 16 within which occupants may ride, and a tonneau or cargo box 18 disposed aft of the occupant cab. The body 12 is secured to the frame 14, which is depicted as a so-called ladder frame having two longitudinal members with a plurality of lateral members extending therebetween.

Such body-on-frame assemblies are conventionally used in pickup trucks, SUVs, or other relatively large vehicles.

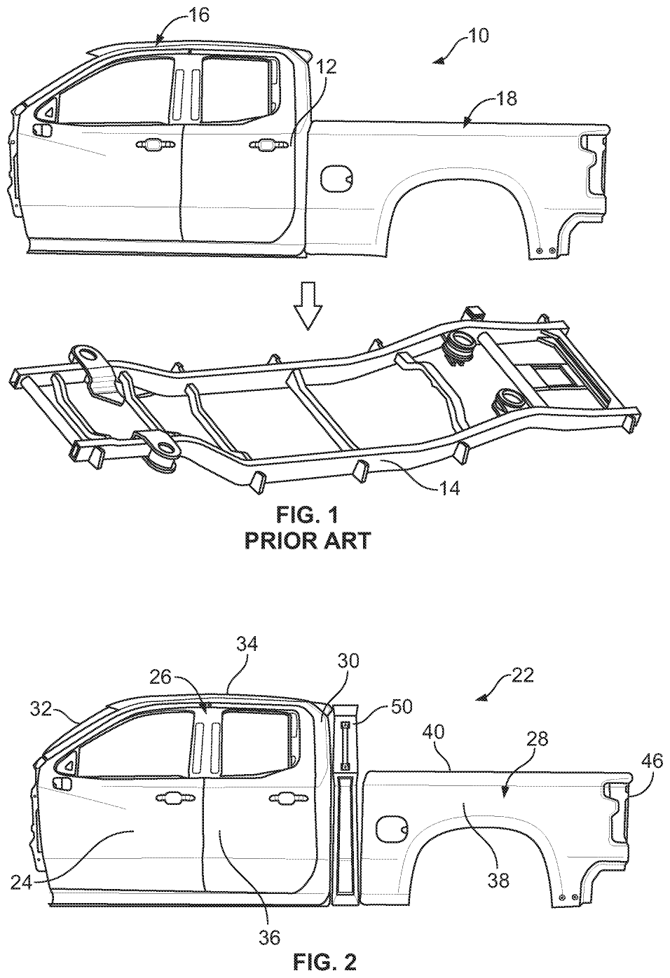

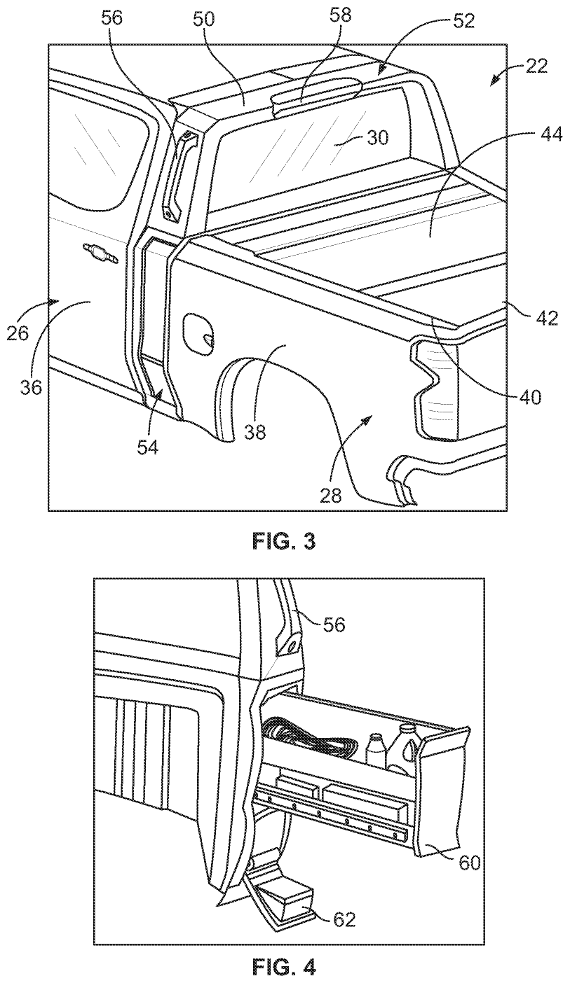

Referring now to FIGS. 2 and 3, a vehicle 22 according to an embodiment of the present disclosure is illustrated. The vehicle 22 may be any one of a number of different types of body-on-frame vehicles, but for purposes of the present example is depicted as a pickup truck. As depicted in FIG. 1, the vehicle 22 includes a body 24 that has an occupant cabin or cab 26 and a tonneau or cargo box 28 rearward of the cab 26.

The cab 26 is generally disposed in front of the cargo box 28 and extends above the cargo box 28. The cab 26 has a back wall 30 that is substantially vertical and which may include a rear window. The front of the cab 26 includes a windshield 32 that slopes rearward from its bottom to its top. The top of the cab 26 is formed by a roof panel 34 that is generally horizontally disposed and that from front to back, extends between the windshield 32 and the back wall 30. From side-to-side, the roof panel 34 extends between sides 36 of the cab 26. The sides 36 of the cab 26 include a driver side 36 and a passenger side 36, and are generally defined by door frames/pillars, and doors which may contain side windows.

The cargo box 28 includes side panels 38 that have top edges at rails 40. The cargo box 28 has a floor referred to as a bed 42, and a front wall 44 positioned aft of the back wall 30 of the cab 26 and extending upward from the bed 42 to the height of the rails 40. The cargo box 28 has a rear opening 46 which may be closed by a tailgate. The rear opening 46 also extends upward from the bed 42 to the height of the rails 40. As a result, the cargo box 28 is formed in the shape of a box with five closed sides and an open top.

Whereas the cab 26 has comparable dimensions to a prior art cab 16, the cargo box 28 is shorter than a prior art box 18 for a given overall vehicle length. A modular utility insert 50 is positioned between the back wall 30 of the cab 26 and the front wall 44 of the cargo box 28. In an exemplary embodiment the utility insert 50 comprises an upper portion 52 and a lower portion 54. The lower portion 54 is generally in register with the cargo box 28, e.g. has an upper boundary at generally the same height as the rails 40. The upper portion 52 is disposed above the lower portion 54 and extends to generally the same height as the cab 26, e.g. has an upper periphery at generally the same height as the roof panel 34. In an exemplary embodiment, the upper portion 52 and lower portion 54 are formed as discrete blow-molded pieces which are secured to one another to form the utility insert 50, and subsequently secured to the cab 26. The assembly of cab 26 and utility insert 50, along with the cargo box 28, may thereafter be assembled to a frame in generally the same fashion as the prior art.

Referring now to FIGS. 3 and 4, features of the utility insert 50 will be discussed in further detail.

In the illustrated embodiment, the upper portion 52 extends generally about a periphery of the rear window of the back wall 30 of the cab 26, projecting generally aft from the back wall 30. The upper portion 52 may be provided with a variety of utility features, which may be integrated into the upper portion 52 or selectively removable therefrom, as appropriate. In the illustrated embodiment, the upper portion 52 is provided with a handle 56 and a center high-mounted stop lamp (CHMSL) 58. In other embodiments the upper portion 52 may also be provided with other utility features including, but not limited to, a so-called “headache rack” to protect the rear window, a roof storage rack, a ladder rack, auxiliary lighting features, other suitable features, or any combination thereof. Moreover, complementary utility features may be provided on both sides of the vehicle 22, e.g. an additional handle 56 on the opposite side of the vehicle.

The lower portion 54 defines a generally hollow structure having an interior storage space. The lower portion 54 may be provided with a variety of utility features which make use of the interior storage space. In the illustrated embodiment, the lower portion 54 is provided with a slide-out drawer 60 and a deployable step 62. Advantageously, in the illustrated embodiment, an operator may utilize the deployable step 62 and handle 56 to facilitate access to the cargo box 28 or roof area of the cab 26. In other embodiments the lower portion may also be provided with other utility features including, but not limited to, a lock for the pull-out drawer, additional storage areas, other suitable features, or any combination thereof. Moreover, complementary utility features may be provided on both sides of the vehicle 22, e.g. an additional deployable step 62 and additional drawer 60 on the opposite side of the vehicle.

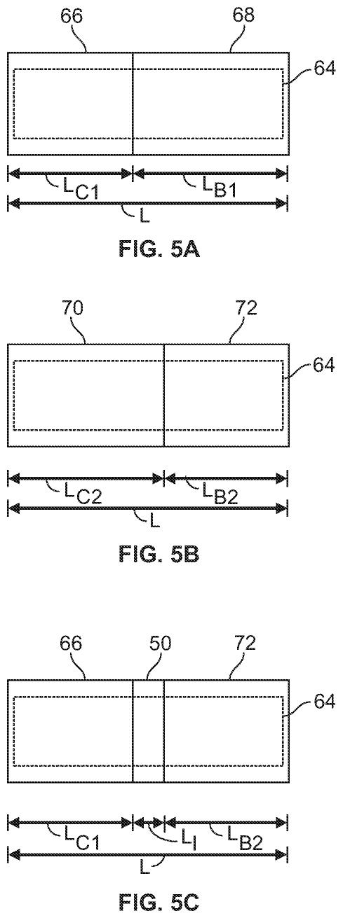

Advantageously, due to the modular nature of the utility insert 50, a common frame along with common cab 26 and cargo box 28 options may be used among a plurality of potential vehicle configurations, including configurations both with and without the utility insert 50. Various potential configurations are illustrated schematically in FIGS. 5a through 5c. As an example, a standard frame 64 may be used in conjunction with a standard (“double”) cab 66 having a length Lci and a standard cargo box 68 having a length LB1 in a first configuration having an overall vehicle length L, as illustrated in FIG. 5a. The frame 64 may also be used in conjunction with an extended (“crew”) cab 70 having a length L_{C2} and a short cargo box 72 having a length L_{B2} in a second configuration having the same overall length L, as illustrated in FIG. 5b, where L_{C2} is greater than L_{C1} and L_{B2} is less than L_{B1}. The frame 64 may else be used in conjunction with the double cab 66, the short cargo box 72, and the utility insert 50 in a third configuration as illustrated in FIG. 5c. The utility insert 50 has a length Li such that the third configuration has the same overall length L.

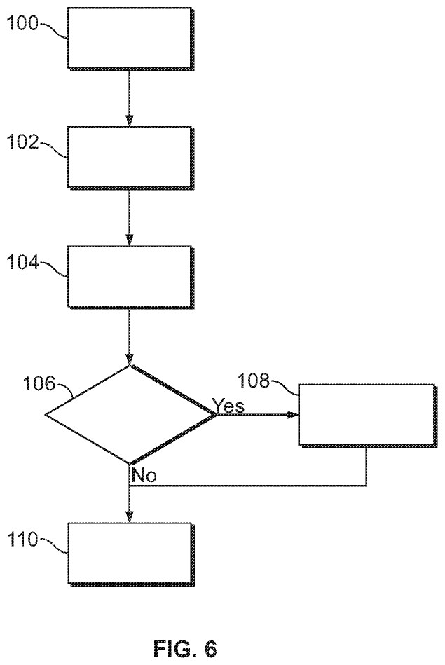

Referring now to FIG. 6, a method of configuring a vehicle according to an embodiment of the present disclosure is illustrated in flowchart form. The method begins at block 100 with providing a vehicle frame.

A cab is provided and coupled to the frame, as illustrated at block 102. In an exemplary embodiment the cab is a double cab; however in various other embodiments alternate cab configurations, e.g. a crew cab, may be used.

A cargo box is selected, as illustrated at block 104. The cargo box is selected from among at least a first cargo box configuration and a second cargo box configuration, where the second cargo box configuration has a length exceeding that of the first cargo box configuration.

A determination is made of whether the selected frame, cab, and cargo box provide space for a modular utility insert, as illustrated in block 106. In the exemplary embodiment described above, this determination may be satisfied by a combination of a double cab and the first cargo box configuration; however various other configurations may likewise provide space for a modular utility insert.

In response to the determination of operation 106 being positive, i.e. adequate space being present for the insert, the insert is secured aft of the cab, as illustrated at block 108. The insert may be secured aft of the cab by any suitable means, such as fasteners or welding. The insert may be secured to the cab, to the frame, or both.

The cargo box is coupled to the frame, as illustrated at block 110. Likewise, in response to the determination of operation 106 being negative, the cargo box is coupled to the frame.

As will be appreciated by one of ordinary skill in the art, the above steps may be provided in order other than that explicitly described. The various body components and frame may be coupled to one another in any suitable order, according to the desired implementation.

The above-described method may be performed either by an original equipment manufacturer or as a modification process subsequent to the original manufacture. During the initial assembly, a suitable cab length and frame size may also be selected according to a desired final configuration.

As may be seen, the present disclosure provides a modular storage unit for an automotive vehicle and a method of assembling the unit to a vehicle. Such systems and methods enable flexible configuration of a vehicle according to the operator's needs, and moreover do so while utilizing a standard set of body and frame components.

As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An automotive vehicle comprising:
a frame;
an occupant cabin coupled to the frame, the occupant cabin having a fore wall and an aft wall;
a cargo box coupled to the frame, the cargo box having a fore sidewall positioned aft of the cabin aft wall; and
an insert disposed between the cabin aft wall and the cargo box fore sidewall, the insert comprising an interior storage space.

2. The automotive vehicle of claim 1, further comprising a removable drawer disposed in the interior storage space.

3. The automotive vehicle of claim 2, wherein the drawer is lockable to selectively inhibit access to the drawer.

4. The automotive vehicle of 1, further comprising a step coupled to the insert.

5. The automotive vehicle of claim 4, wherein the insert has a first side proximate a driver side of the occupant cabin and a second side proximate a passenger side of the occupant cabin, the step being coupled at the first side of the insert, further comprising a second step coupled to the second side of the insert.

6. The automotive vehicle of claim 1, wherein the aft wall is provided with a rear window, and wherein the insert comprises a lower portion and an upper portion, the lower portion being in register with the cargo box, the upper portion extending about the periphery of the rear window.

7. The automotive vehicle of claim 6, further comprising a handle secured to the upper portion.

8. A method of configuring a vehicle comprising:
providing a frame;
providing an occupant cabin coupled to the frame;
selecting among a first cargo box and a second cargo box, the second cargo box having a length exceeding the first cargo box;
in response to the first cargo box being selected, disposing an insert between the occupant cabin and the first cargo box, the insert having an interior storage space; and
coupling the cargo box to the frame.

9. The method of claim 8, further comprising coupling the insert to the occupant cabin.

10. The method of claim 8, further comprising providing the insert with at least one removable drawer disposed in the interior storage space.

11. The method of claim 8, further comprising, in response to the second cargo box being selected, coupling the cargo box to the frame with no insert therebetween.
